(19) United States
(12) Patent Application Publication
(10) Pub. No.: US 2024/0298568 A1
(43) Pub. Date: Sep. 12, 2024

(54) Applicator Control User Interface

(71) Applicant: Stinger Equipment, Inc., Buckner, KY (US)

(72) Inventors: David Michael Cook, LaGrange, KY (US); Stephen W. Brewer, New Albany, IN (US)

(21) Appl. No.: 18/487,547

(22) Filed: Oct. 16, 2023

Related U.S. Application Data
(63) Continuation-in-part of application No. 17/501,795, filed on Oct. 14, 2021.
(60) Provisional application No. 63/091,781, filed on Oct. 14, 2020.

(51) Int. Cl. A01C 17/00; A01M 7/00; G06F 3/0482

(52) U.S. Cl. CPC A01C 17/008; A01C 17/001; A01M 7/0042; A01M 7/0089; G06F 3/0482

(57) ABSTRACT

An applicator including: a frame with hopper mounted thereon to hold and dispense a granule product, the hopper including an electronically controlled gate(s); a tank to hold a liquid product; a electronically controlled spray tip(s) to dispense the liquid product; a spray pump located between the tank and spray tip(s); an operator control interface for receiving input from an operator; a control coupled to the operator control interface, the electronically controlled gate(s), and the spray tip(s), where the control receives input, dispenses the liquid or granule product based on the input received from the operator control; where when the liquid product is dispensed, the control provides a signal to the spray tip(s) to regulate a flow of the liquid product, and when the granule product is dispensed, the control provides a signal to the electronically controlled gate(s) to regulate a flow of the granule product.

### BACKGROUND OF THE INVENTION

In the commercial turf industry, riding applicators that apply fertilizer and spray liquid herbicide have become very popular over the years. These machines have greatly increased the production capacity allowing just one individual to quickly treat large areas, for example dozens of lawns a day. Over the years, there have been large and small machines with different drive systems, but there has been little change in the method for doing the basics of spreading fertilizer and spraying herbicides. While these machines have greatly increased production capacity, they are not user friendly and require extensive training to learn to operate them properly. Furthermore, once an operator has learned to drive the machines, the operator must then learn all the additional controls to spread fertilizer and spray liquid herbicide.

Typically, if the operator wants to spread fertilizer the operator needs to set the impeller speed so the fertilizer is thrown the desired width for the machine. Then, the operator must calibrate the machine to get a proper amount of material flowing; then, the operator must calibrate and ensure the machine is running at a specific speed (normally 5 mph) so the material is applied at the correct rate. Once each of these steps is completed, the operator can begin spreading the fertilizer. To spread fertilizer, the operator needs to safely maneuver the machine while also turning the fertilizer on/off or further adjusting the dispensing of the fertilizer. For example, when approaching an edge, the operator may lower a side deflector to limit and control the width of the spread while also reducing the amount of fertilizer to compensate for the narrower width. In another example, where an operator is working on a smaller property, there may be a need to narrow the throw to spread the fertilizer accurately. In order to accomplish this, the operator may need to repeat the calibration process for a narrower width, and may also need to manually adjust the impeller speed and material settings for the new flow rate. Due to the amount of effort required to adjust a fertilizer spreader, operators often just use a single setting because it is too much work to adjust the settings over the course of a day. This may result in over and/or under application of material, but primarily over application, as product may be spread into areas where it is not needed (e.g. roads, driveways, flower beds, etc.).

If an operator wants to spray liquid herbicide, the process is similar. The operator may calibrate the machine for a single speed (normally 5 mph) and then turn the sprayer on while trying to maintain that specific speed. If the operator wants to spray wider or narrower, different spray tips can be used to make the machine wider or narrower. However, when this is done, the operator must adjust the spray pressure to compensate for the adjustment in flow for the narrower or wider width of spray.

Once the machine has been calibrated and setup, an operator must drive the machine across a property maintaining even spacing, at a constant speed, while also turning the sprayer and/or spreader on or off while making turns. Because of this, the operator is constantly adjusting control settings, flipping multiple switches and/or levers (to turn these items on and off), while also trying to maintain a specific speed and pattern. With this operator workload, it takes a trained operator to operate a machine correctly.

There is a need in the art for a riding applicator control system that can reduce the work load for an operator. There is also a need in the art for the machine to be able to apply material at varying speeds to increase accuracy and efficiency.

The information included in this Background section of the specification, including any references cited herein and any description or discussion thereof, is included for technical reference purposes only and is not to be regarded subject matter by which the scope of the invention is to be bound.

### SUMMARY OF THE INVENTION

The present application discloses one or more of the features recited in the appended claims and/or the following features which alone or in any combination, may comprise patentable subject matter.

The object of the embodiments described herein is to provide a control system to greatly reduce operator workload and automate at least a portion of the process. It may be desirable for the system to be setup and calibrated so as to allow the operator to select the functionality desired for the products being applied, so that the operator may focus on driving the machine. The machine may also be ground metered with both spreading and spraying. The reduction in operator workload coupled with ground metering may allow for a more accurate and efficient machine to operate.

In one aspect an applicator machine includes: a frame; a hopper mounted to the frame to hold and dispense a granule product, where the hopper also includes one or more electronically controlled gates; a tank to hold a liquid product; one or more electronically controlled spray tips to dispense the liquid product; a spray pump located between the tank and the one or more spray tips; an operator control interface to receive input from an operator; a control coupled to the operator control interface, the one or more electronically controlled gates, and the one or more electronically controlled spray tips, the control configured to: receive input from the operator control; dispense the liquid product or the granule product based on the input received from the operator control; and when the liquid product is dispensed, the control provides a signal to the one or more electronically controlled spray tips to regulate a flow of the liquid product and when the granule product is dispensed, the control provides a signal to the one or more electronically controlled gates to regulate a flow of the granule product.

In some embodiments, the input received from the operator control is a selection of a spray mode or a spread mode. In some such embodiments, the machine further includes one or more actuators coupled to the control, where the controller is then further configured to: in response to actuation of the actuator by the operator, dispense the liquid product when the spray mode is selected; or in response to actuation of the actuator by the operator, dispense the granule product when the spread mode is selected.

In some embodiments, the input received from the operator control is a selection of one or more spray patterns.

In other embodiments, the input received from the operator control is a selection of one or more spread patterns. In some such embodiments, the control is further configured to alter a speed of an impeller based on the selection of the one or more spread patterns. In other such embodiments, the regulation of the flow of the granule product by the electronically controlled gates is based on the one or more spray patterns selected.

In some embodiments, the input received from the operator control is a selection a preset or custom calibration. In other embodiments, a speed of the spray pump varies. In some such embodiments, the speed of the spray pump increases when the one or more electronically controlled spray tips are activated.

In some embodiments, the control is further configured to: activate an agitation mode based on operator input to the operator control; where when the one or more electronically controlled spray tips are inactive, a three-way valve switches to a large nozzle returning the liquid product to the tank, and when the one or more spray tips are active, the three-way valve is switches to a small nozzle directing the liquid product to the one or more spray tips.

In some embodiments, the control is further configured to ground meter the flow of the liquid product or the flow of the granule product based on speed data. In some such embodiments, the speed data is obtained from one or more wheel speed sensors located on one or more drive wheels. In some embodiments, the control is further configured to: determine, based on the speed data, whether the applicator machine is turning; determine, based on the speed data, a direction and a magnitude of the turn; and adjust the flow of the liquid product or the flow of the granule product based on the direction and magnitude of the turn.

In some embodiments, the hopper further includes a material vibrator coupled to the control, such that the control activates the material vibrator when the one or more electronically controlled gates are open.

In another aspect, an applicator machine includes: a frame; a hopper mounted to the frame to hold and dispense a granule product, where the hopper further includes one or more electronically controlled gates; a tank to hold a liquid product; one or more electronically controlled spray tips to dispense the liquid product; a spray pump disposed between the tank and the one or more spray tips; an operator control interface to receive input from an operator; a control coupled to the operator control interface, the one or more electronically controlled gates, and the one or more electronically controlled spray tips, the control configured to: receive, from the operator control, a calibration selection; receive, from the operator control, a mode selection from the operator; receive, from the operator control, a pattern selection; and dispense, the liquid product or the granule product, based on the calibration selection, the mode selection, or the pattern selection.

In some embodiments, the control is further configured to regulate of the flow of the granule product by actuation of the electronically controlled gates based the calibration selection, the mode selection, or the pattern selection. In some embodiments, a speed of the spray pump increases or decreases to hold a desired pressure through the feedback from a pressure transducer as the flow demand increases or decreased with an increase or decrease of ground speed

In some embodiments, the control is further configured to ground meter a flow of the liquid product or a flow of the granule product based on speed data. In some embodiments, the speed data is obtained from one or more wheel speed sensors disposed on one or more drive wheels. In some such embodiments, the control is further configured to: determine, based on the speed data, whether the applicator machine is turning; determine, based on the speed data, a direction and a magnitude of the turn; and adjust the flow of the liquid product or the flow of the granule product based on the direction and magnitude of the turn.

The term “controller” or “processor” is used herein generally to describe various apparatus relating to the operation of the system and the seeding attachment referred to herein. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions.

A processor or controller may be associated with one or more storage media (generically referred to herein as “memory,” e.g., volatile and non-volatile computer memory). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein.

The term “Internet” refers to the global computer network providing a variety of information and communication facilities, consisting of interconnected networks using standardized communication protocols. The apparatuses, controllers and processors referred to herein may be operatively connected to the Internet.

### BRIEF DESCRIPTION OF THE DRAWINGS

In order that the embodiments may be better understood, embodiments of an applicator control user interface will now be described by way of examples. These embodiments are not to limit the scope of the claims as other embodiments of an orthopedic brace will become apparent to one having ordinary skill in the art upon reading the instant description. Non-limiting examples of the present embodiments are shown in figures wherein:

FIG. 1 illustrates an applicator control consistent with some embodiments described herein.

FIG. 2 illustrates an applicator control and control handles consistent with some embodiments described herein.

FIG. 3 illustrates wide and narrow spray diagrams consistent with some embodiments described herein.

FIG. 4 illustrates wide and narrow spreader diagrams consistent with some embodiments described herein.

FIG. 5 illustrates a side deflector consistent with some embodiments described herein.

FIG. 6 is a schematic of a tank agitation system consistent with some embodiments described herein.

FIG. 7 illustrates a spot spray diagram consistent with some embodiments described herein.

FIG. 8 illustrates wheel speed sensors consistent with some embodiments described herein.

FIG. 9 illustrates a pulse width modulated spray tip signal consistent with some embodiments described herein.

FIG. 10 illustrates a spreader pattern for an applicator with electronically controlled material gates consistent with some embodiments described herein.

FIG. 11 illustrates a hopper with servo controls and vibrator consistent with some embodiments described herein.

FIG. 12 illustrates an exploded view of the hopper with servo controls of FIG. 11 consistent with some embodiments described herein.

FIG. 13 illustrates a portion of the hopper and servo controls of FIG. 11 consistent with some embodiments described herein.

FIG. 14 illustrates an exploded view of a portion of the hopper with servo controls of FIG. 11 consistent with some embodiments described herein.

FIG. 15 is a block diagram of a control system consistent with some embodiments described herein.

FIG. 16 is an exemplary spread calibration table consistent with some embodiments described herein.

FIG. 17 is an exemplary spray calibration table consistent with some embodiments described herein.

### DETAILED DESCRIPTION OF THE INVENTION

It is to be understood that an applicator control user interface and system is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

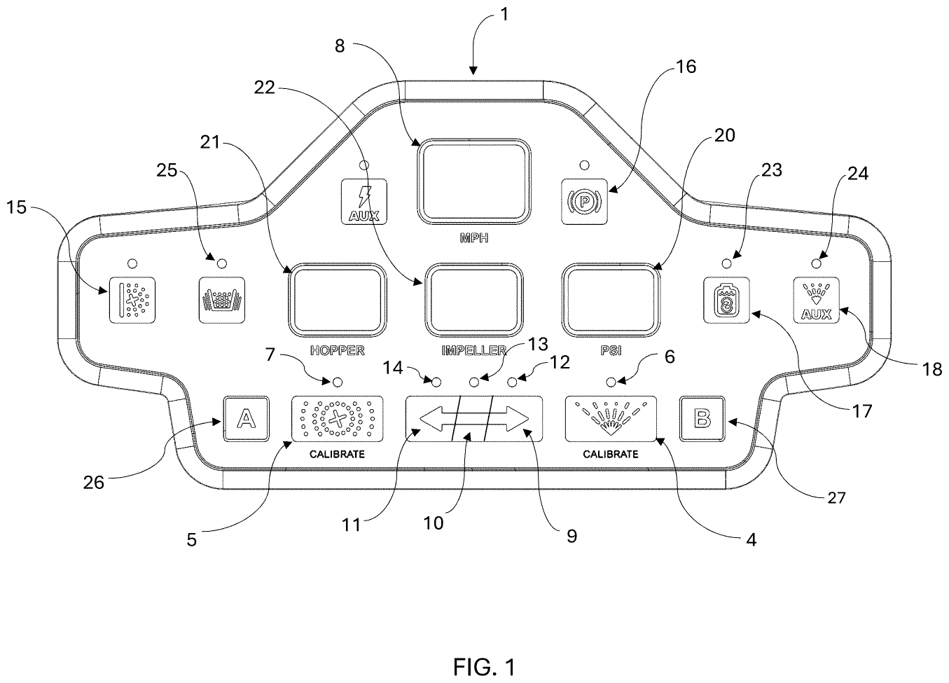

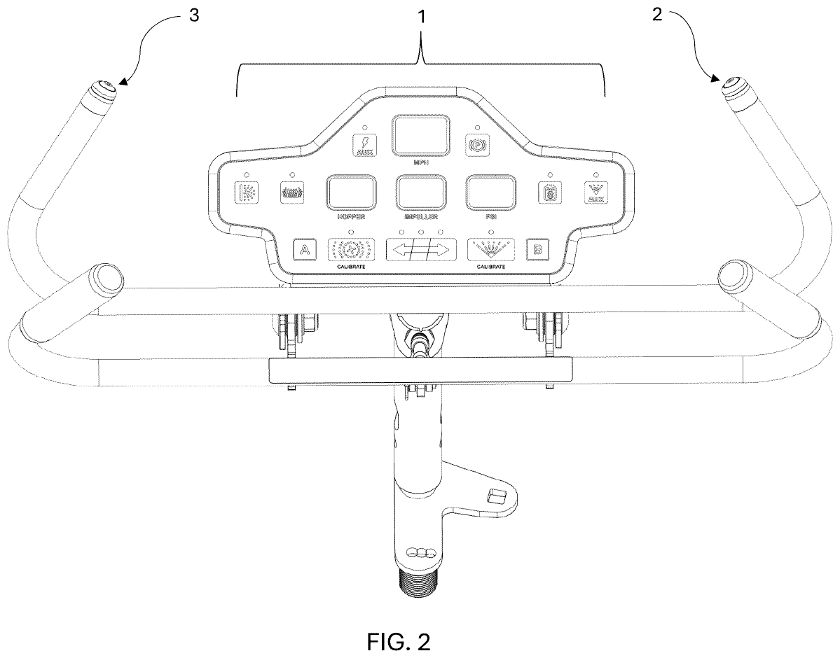

FIGS. 1-2 illustrate an exemplary operator control interface 1 as described herein. The control interface 1 may allow the operator to select a mode of operation (for example sprayer or spreader) and then operate the system with as little as one button press for all functions simultaneously as it pertains to spreading or spraying with the system. In some implementations, the system may be setup and calibrated by a system manager, which may allow for the setup of a fleet of machines simultaneously. In other implementations, an operator may independently set up a single machine. Assuming proper setup and calibration, the machine may operate as described herein. To begin spreading or spraying, an operator may select the mode(s) desired on the control interface 1. For example, to enable spraying, the operator may press a spray mode select button 4. As another example, to enable spreading, the operator may press the spread mode select button 5. The operator may select either one of the spray or spread mode select buttons 4, 5, or both to enable the selected feature(s) for use. Once a particular mode is selected, a corresponding indicator may be activated. In some implementations, such an indicator may be one or more corresponding LEDs 6, 7 that may illuminate above the corresponding selection button. In other implementations, the indicator may be an illumination of the button itself, an audio indication, or any other type of indication known in the art.

Once the mode(s) is selected, an operator may begin applying the selected substance(s). The operator may begin by driving the machine to achieve the calibrated speed, which may be illustrated on the speed (e.g. miles per hour, kilometers per hour) display 8 (located in the center of the control interface 1 in the illustrated embodiment). Once at the calibrated speed, the operator may activate a right actuator 2 to enable to system to begin spreading and/or spraying, depending on the mode selected. In some implementations, this right actuator may be in the form of a right momentary thumb switch, that may be easily actuated by an operator's thumb; however, this is not intended to be limiting, as the right actuator may be in the form of a knob, button, switch, or the like. To stop the operation, an operator may activate the right actuator 2 (e.g. a right momentary thumb switch) again to turn the system off and cease the application of product. In some implementations, where product is being applied (regardless of the mode) there is an indication to the operator that the mode is actively engaged. In some such implementations, this indication may be the corresponding LED 6, 7 blinking to indicate the mode is actively engaged. When the operator turns the system off the indication may stop; for example, the blinking LEDs 6, 7 may return to a steady on state until the operator deselects that mode. Once a particular mode is deselected, the corresponding LED 6, 7 may turn off.

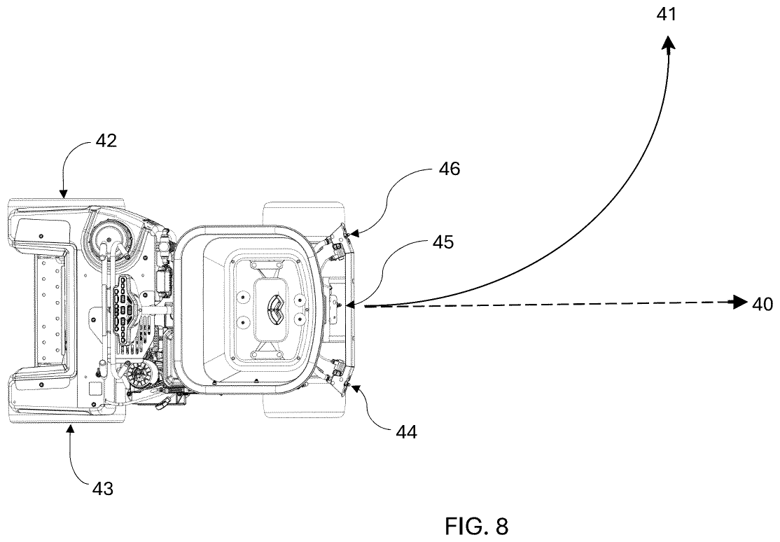

When the spray mode is selected and enabled, the system may automatically turn the pump (see e.g. 33 in FIG. 8) on to enable spraying, activate one or more spray tips (see e.g. 30, 31, 32 in FIG. 8), if applicable, and regulate the spray pressure. When the spreader mode is selected and enabled, the spreader motor may be on and the spreader may begin to spread material automatically. Both spreading and spraying have a calibration process that sets the parameters used by the system.

When spreading, one or more display screens may show the current hopper opening setting and/or a current impeller speed. When spraying the one or more display screens may show the spray pressure (e.g. in PSI). In the illustrated embodiment these are separate and distinct display screens; for example, there may be a hopper display 21, an impeller display 22, and/or a PSI display 20. In other implementations, some or all of these may be displayed on the same screen. Regardless of the mode of operation, the speed is displayed. In some implementations, such as illustrated herein, the speed may also be displayed on a separate display (e.g. the speed display 8 in FIG. 1), but this is not intended to be limiting.

The control interface 1 may further include a user interfaces, for example a button, knob, or the like to select a wide, narrow, offset spray or spread pattern. The system may be capable of spraying and spreading a narrow width pattern, a wide width pattern, or an offset right/left pattern. In order for an operator to alter the spray or spread pattern, the operator may select the pattern desired. Such a selection may be made in advance of operation, or may also be while the system is actively applying product. In some implementations, such as illustrated herein, the adjustment to the pattern width applies to both spread and spray applications simultaneously. For example, when the operator is selecting the spray and/or spread mode, as described above, the operator may momentarily press the center of the wide arrow button 10 to toggle between wide or narrow applications. This wide arrow button (collectively 9, 10, 11) is really three independent switches working together and/or independently based on how selected by the operator. For example, if the operator does a momentary press on the center of the wide arrow button 10, it will toggle between wide or narrow modes. An indicator may alert the operator to which application width is selected. For example, this indicator may be a visual display of the application width selected, which may be in the form of the one or more LEDs. In some implementations three separate LEDs 12, 13, 14 may be used as indicators. In such instances, where all three LEDs 12, 13, 14 are on, then the machine may be setup for wide applications; whereas, if just the center LED 13 is on, then the machine may be setup for narrow applications. In other implementations, the indication of the selected width may be done with a single LED of varying colors, patterns, etc.

Additionally, an operator may actuate the left or right arrow button 9, 11 momentarily to enable an application pattern skewed to either the right or left instantaneously even while actively spreading and or spraying. In some implementations, the skewed selection mode may only be available when the machine is in a standby mode. With a momentary press on the arrow button, skewed selection may be made available, allowing an operator to select left, right, or center. For example, the operator may be able to make additional sections with the following application patterns by selecting one or more of the individual components of the wide arrow button 9, 10, 11. For example, left only 11, right only 9, left and center 11,10, right and center 9, 10, or all three of left, right, and center 9, 10, 11. However, in some implementations, the operator may not be able to select left 11 and right 9 without the center 10. To leave the skewed pattern mode, an operator may actuate the center of the wide arrow button 10. While illustrated and described herein, it is to be understood that not all machines and/or control systems may have the ability to enable a skewed application pattern, and that some machines and/or control systems may only include the wide and narrow options.

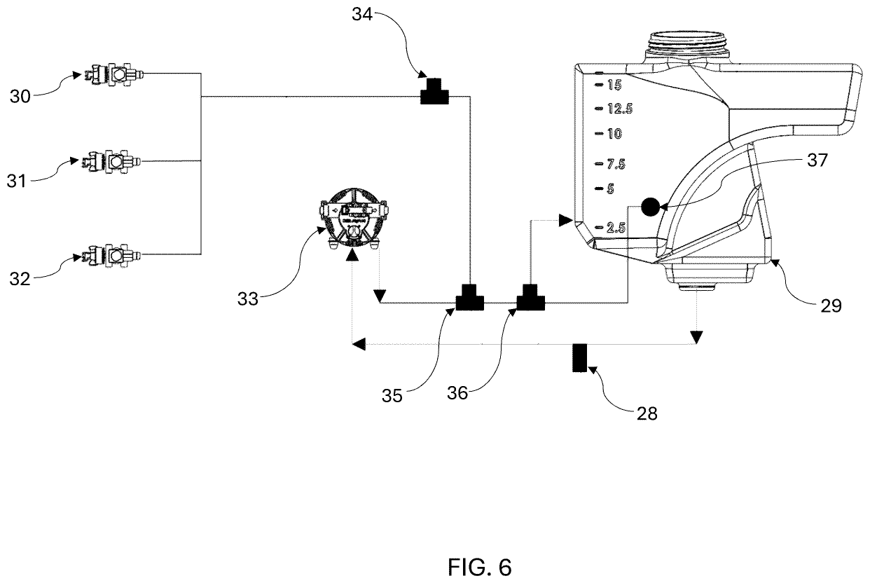

Wide and/or narrow pattern spraying and spreading may be achieved by control of spray tips (see e.g. spray tips 30, 31, 32 of FIG. 6) or control of the impeller speed. For example, while spraying in the narrow mode only the center spray tip or spray section may be enabled; while in wide mode, the wide spray tips or all spray tips (see e.g. spray tips 30, 31, 32 of FIG. 6) may be enabled. For spreading, in the narrow mode, the spreader impeller may run at a slower speed to reduce the width of the spread pattern; while a wide-spread pattern may have a faster impeller speed and an increased material flow to correspond with the wide application rate. Additionally, in some implementations, the hopper opening automatically may also be adjusted to reduce material flow to correlate with the selected width. This automation will greatly reduce the operator workload when needing to quickly change from narrow or wide application rates. As mentioned previously, in some implementations, an operator may be able to select a skewed pattern. Such a skewed pattern may be achieved by controlling spray tips individually or by controlling spray sections, depending on the number of spray tips on the machine.

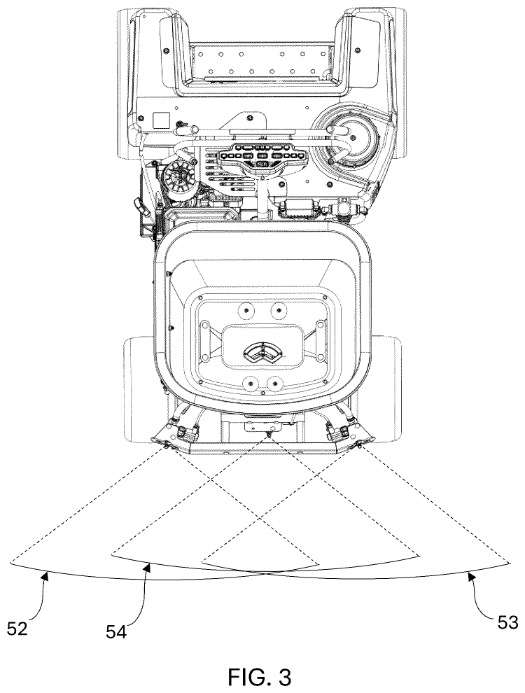

FIG. 3 illustrates an exemplary arrangement of spray tips providing wide, narrow, and skewed spray patterns. In the illustrated embodiment a wide spray pattern would encompass spray pattern 52 and spray pattern 53; while a narrow spray pattern would be spray pattern 54. In implementations where a skewed spray pattern is enabled, a skewed pattern to the right would be spray pattern 52 only, while a skewed spray pattern to the left would be spray pattern 53 only.

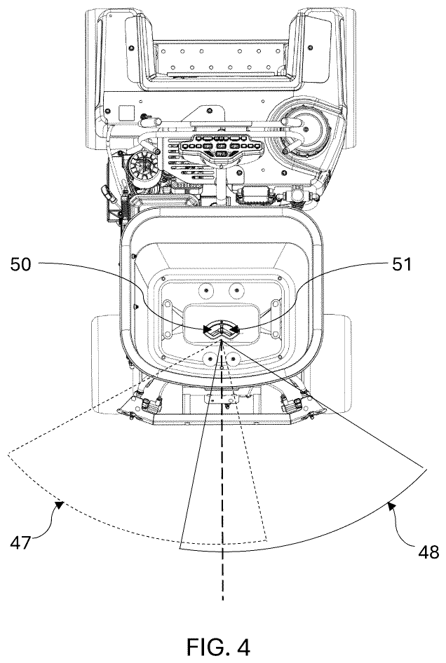

A spreader can also achieve a skewed pattern, for example by using two or more gate openings that are controlled independently with servos. FIG. 4 illustrates an example of how a spreader with two gate openings 50, 51 may achieve this functionality. For example, in the illustrated embodiment, a wide spread pattern spread pattern may be achieved with spread pattern 47 and spread pattern 48 in combination. In some implementations, a wider spread pattern may be achieved by increasing the speed of the spreader impeller to throw the material further. Additionally, or alternatively, the gate openings 50, 51 may also be increased to allow for more material flow and compensate for the larger area covered.

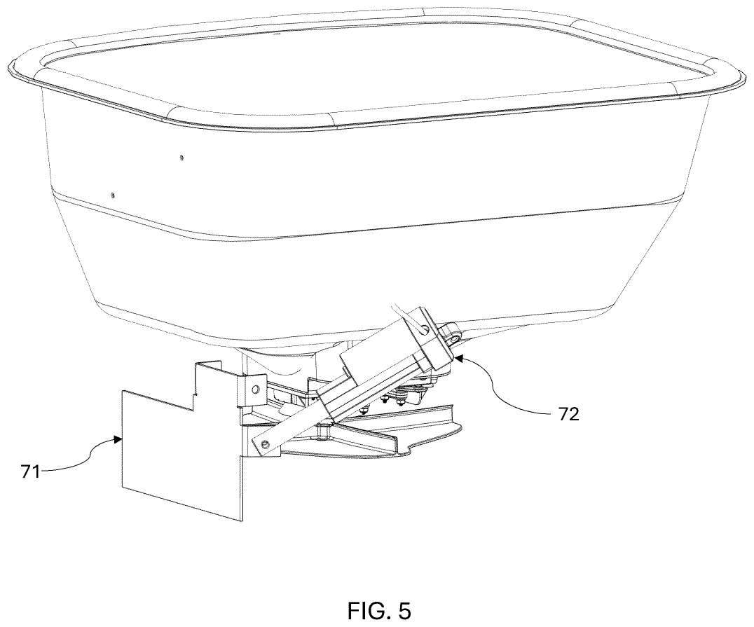

FIG. 5 illustrates a side deflector 71 that may, in some instances, be used to help control the width or make sharp distinct lines where fertilizer should start and stop to the side of a machine. For example, a side deflector 71, may be used applying along a hard surface like a driveway or roadway. In the system described herein, an operator may enable a side deflector 71 mode using a deflector button (see 15 in FIG. 1) at any time. When selected (regardless of whether the machine is actively applying product or in standby mode), the deflector 71 may lower automatically and the material flowing to that side of the machine may be reduced by reducing the opening at the fertilizer hopper with the servo-controlled opening. Furthermore, if spraying and spreading while this feature is enabled, the side with the deflector 71 may also stop spraying to prevent spraying past the desired point. The edge of the spray width may or may not perfectly align with the hard edge created with the side deflector, depending on the size and design of the system. Conventionally, the side deflector 71 is used while spreading only, but is not so limited and may, as described, also be used while spraying.

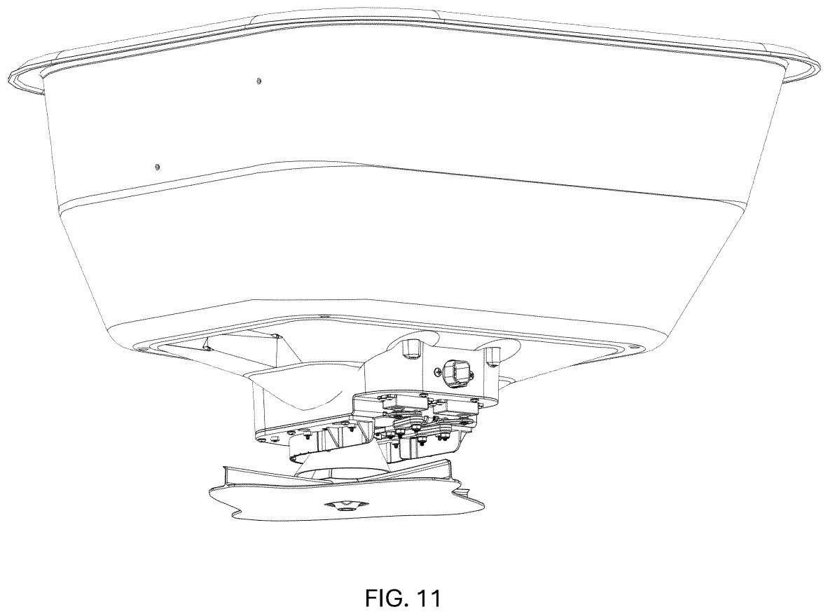

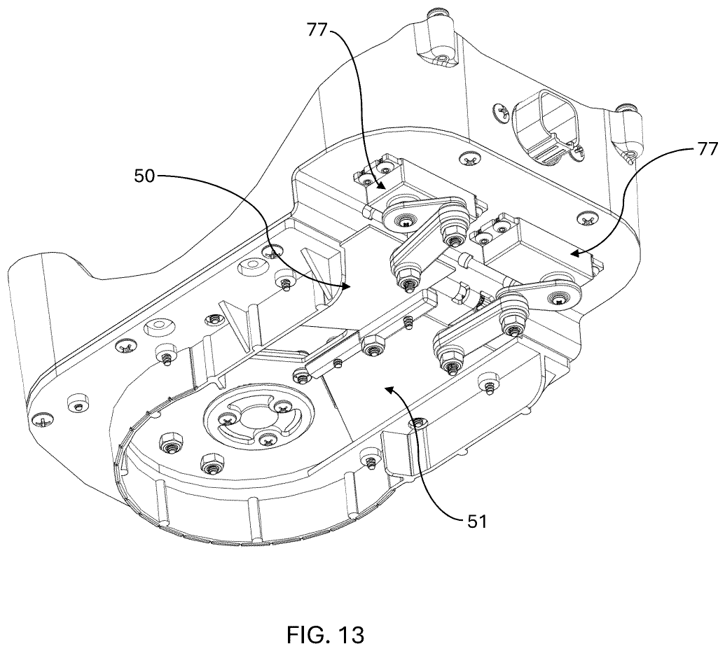

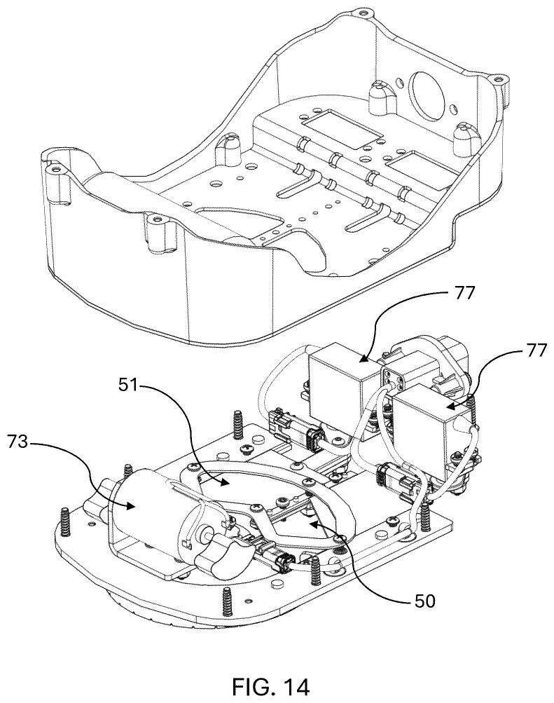

Turning now to FIG. 11-14, a fertilizer hopper with two servo-controlled openings is illustrated. This hopper may hold any solid fertilizer product, including but not limited to granules, prills, etc. Each servo-controlled opening 50, 51 allows the system to turn the spreader on and off automatically, but it also allows for quick and automatic change of the flowrate depending on the mode selected. For example, a controller may send a position signal, based on operator input to the control interface, to one or more servos 77 to direct its movement. This movement can be to a fully closed position, fully open position, or any other position or movement. The system further allows the hopper openings to break up material clogs that would normally block a spreader from applying material. For example, the servo-controlled gate openings 50, 51 may be designed to rapidly open past the desired calibration opening and then return very quickly while applying product. This quick gate opening may appear like the servo 77 is twitching, but it is designed into the system, so the quick movements help break up chunks of material by crushing it in the gate opening 50, 51. Traditional fertilizer hoppers open to apply product through a single opening, which may lead to material clogs. In these traditional systems, when a material clog occurs, an operator may be required to fully open the gate in an effort to clear the clog; however, by this time it is often too late clearing the clog may require emptying the hopper of material. While described and illustrated as being servo-controlled, control of the gates is not intended so limited. It is to be understood than any kind of electronic control of the gate opening is within the scope of the present disclosure.

The fertilizer hopper may also be designed with a material vibrator 76 to provide a small vibration to the hopper to improve material flow when applying product. This small vibration allows for a more consistent material flow from a full hopper to an empty hopper. The vibration may also help to prevent material from bridging in the hopper preventing clogs in the present of humidity which can make the material stick and prone to clogging. In some instances, the vibrator runs at a low vibration setting continuously but only when actively spreading, and the operator may option to increase the aggressiveness of the vibration based on the material being applied. To increase the fertilizer hopper vibration/agitation, an operator may press the hopper vibration button (see e.g. 19 in FIG. 1). In some implementations, the operator may toggle through a plurality of preset vibration programs, where each one may increase in intensity. These programs are designed to vary the intensity of the vibration and work only when actively spreading material. When the hopper gates are closed and not spreading, the vibration action is also disabled. The vibration selected may, in some implementations, be temporarily displayed in the hopper display (see e.g. 21 in FIG. 1). In some implementations, there may also be an indictor to provide an indication to the operator that the hopper vibration is activated. For example, in the illustrated embodiment, LED 25 (see FIG. 1) located above the hopper vibration may be illuminated when one of the preset vibration programs in enabled. To turn the vibration function off, an operator may cycle through the options, until an “off” or “0” is displayed and the feature will turn off. In some instances, it may be desirable for an operator to run the vibrator at max speed manually, for example to clean out the hopper or clear a clog. To achieve this the operator may press and hold the fertilizer vibration button for two or more seconds, which may allow the vibrator to continue to vibrate at maximum speed while the button is actuated. In such implementations, once release the button is released or disengaged the vibration feature will return the previous state.

FIG. 6 illustrates how the system mixes or agitates the chemical spray tank. When a spray pump 33 is running, there may be some continuous tank agitation. Tank agitation is where some or all the liquid being pumped is returned to the spray tank for a mixing action in order to keep chemical suspended in water mixed and thoroughly suspending for spraying. In some instances, the system may include a small tank agitation nozzle or return 38 and a larger agitation nozzle 37, which may be used for higher flow rates, each of which allows flow back to the tank. In some implementations, each nozzle may be selectively controlled using a manual valve. In the illustrated embodiment, the valve 36 is automatic. When the spray mode is selected, the main spray pump 33 runs at a slow speed for minimal tank agitation and holds a target spray pressure normally 30 psi; however, when the spray mode is activated, the spray pump 33 may increase in speed to provide adequate pressure, normally 30 psi, as spray tips 30, 31, 32 are enabled. If an operator selects the tank agitation mode button (see 17, FIG. 1) the tank 29 will be mixed aggressively by switching valve 36 to enable all flow to tank agitation nozzle 37. The electronic valve 36 may also be an on/off valve where in the off position there is minimal flow back to the tank at all times thus eliminating the need for return 38. The level of agitation may be changed between a plurality of predetermined level, for example by toggling through intensity levels. For example, the number “3” for high intensity mixing may be shown temporarily on the PSI display (see e.g. 20 in FIG. 1); the operator may also toggle through program intensity from “0” for off, “1” for low, “2” for medium, and “3” for high agitation. The display indication of intensity provided herein (e.g. numbers 1-3) are merely exemplary, in other instances the words “high”, “medium”, or “low” may be displayed as the indicator to the operator. This feature may also be used when mixing a new tank 29 of chemicals, when needing to keep chemicals in powder form suspended for spraying, or to minimizer and/or prevent settling of chemical to the bottom of the tank.

In agitation mode, while not spraying, the pump flow increases, and the valve 36, which may, for example, be a three-way valve or on/off valve which has minimal flow in the off position, may be switched on to the larger agitation nozzle 37 that goes back to the tank 29. This increased flow and larger nozzle 37 can mix the tank more aggressively. Once spraying starts, the three-way valve 36 may switch back to the smaller agitation nozzle 38 or off if an on/off valve is used and most of the flow can be directed and used for spraying instead of mixing. When the pump is running, a pressure sensor 34 may send a signal back to a controller, where the controller logic can process the signal to determine the current pressure. When spraying, the controller may vary the voltage output the pump 33 making the pump increase or decrease as needed to meet the desired spray pressure. When spraying stops, the three-way valve 36 may redirect flow back to the larger agitation nozzle 37 and the pump 33 may increase the pumping speed for mixing the tank. Additionally, this valve 36 may allow for a smaller pump 33 and/or less power use, so all the flow can either be sent to tank 29 for mixing or the majority of the flow can be sent to the spray tips 30, 31, 32 for spraying.

An additional agitation mode can be used to mix the tank 29 with the machine off and not running. If an operator wanted to keep the tank 29 mixed while stopped, or while transporting the machine from one job the next, they have that option. The operator can press and hold the tank agitation button (see e.g. 17 in FIG. 1) for a predetermined length of time (e.g. at least two seconds) while the engine is off. After this predetermined length of time (e.g. the at least two seconds) an LED (see e.g. 23 in FIG. 1) will begin to flash, and the system will enter a low power agitation mode. This standby agitation mode may keep a tank 29 in agitation. In some instances, the operator may toggle through preset agitation settings; for example, as the operator continues to momentary press the tank agitation button 17 the agitation mode options will be shown in the PSI display 20. In some instances, there may be five options (for example ranging from 1-5), where each option can mix the tank 29 more aggressively. The display indication of agitation provided herein (e.g. numbers 1-5) are merely exemplary, in other instances the words “high”, “medium”, or “low” may be displayed as an indicator to the operator. Since this mode is enabled even when the machine is off, the controller will turn the mixing mode off when the battery voltage reaches a low voltage threshold automatically. In low voltage shut down mode, the LED 23 will quickly flash three times with a pause and keep repeating the cycle. The feature may start again automatically after the engine charges the battery to a normal level. In some instances, this feature may be disabled by pressing and holding the tank agitation button 17 for a predetermined length of time (e.g. at least two seconds). After the predetermined length of time the LED 23 may turn off. It would also be possible to set an automatic off for this agitation mode based on a time interval for examples 30 min and then the mode will turn off.

FIG. 6 also shows the spray pump plumbing. In some instances, the sprayer system plumbing may also include a strainer 28 (filter) to remove small particles located between the spray tank 29 and the pump 33. There may also be a “T” fitting 35 that allows pressure to flow to the spray tips 30, 31, 32; it is located between the pump 33 and the three fitting 35. The spray pressure may be controlled by monitoring the system pressure using a pressure transducer 34 providing feedback to the controller 1. The controller can interpret the signal to increase or decrease the voltage to the pump 33 to maintain a specific pressure. This pressure may then be displayed on the PSI display 20 when the system is spraying. When an operator selects wide or narrow the pump may automatically adjust to hold a desired pressure. Additionally, since the tank agitation may be setup to have some flow always going back to the tank, the pump 33 can run continuously, which may reduce the number of starts and stops and may increase pump life. Furthermore, since system has open flow back to the tank 29, no pressure stays in the system when the pump is off; this may allow the pump 33 to start easily reducing wear and tear on the pump and minimizing dripping from spray tips due to high pressure left in the spray line. Furthermore, the control interface 1 may include a soft start feature where the pump 33 may be started with a lower voltage instead of the system normal 12-13 volts. Starting at a lower voltage and then increase the voltage to reach a desired speed may also increase the pump service life.

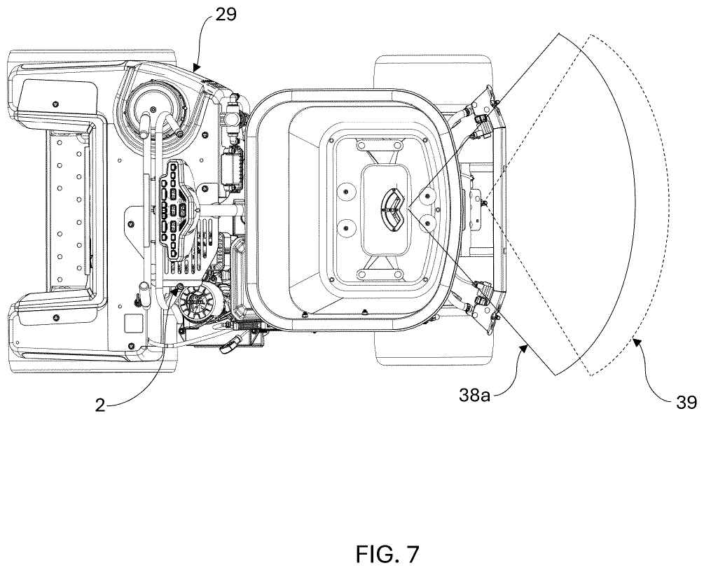

FIG. 7 illustrates spot spray functionality. When applying fertilizer only applications, the operator may see a few weeds and desire to selectively spot spray or treat those areas while spreading fertilizer. Normally, a spray tank 29 will contain herbicide for spot spraying even though the main application may be just fertilizer. When spreading only, an operator may press and hold the left thumb switch (see e.g. 3 in FIG. 2) and while this button is pressed, the spray system will spray 39, FIG. 7 product at the same width that the fertilizer 38 is being applied. For example, if the spreader is in wide mode, the spot spray will be in wide mode; if the spreader is in narrow mode, the spray will be in narrow mode. In the example shown in FIG. 7, the spreader is in the narrow mode. In implementations where the machine has the ability to spread a right or left skewed pattern, the spot spray will do the same.

Additionally, in some implementations, there may be an option for an auxiliary spray tank for selectively applying more expensive herbicides designed to target very select weeds. This may be a smaller secondary tank with its own pump, hand wand applicator, and/or standard spray tip mounted on the front of the machine. This auxiliary spray feature may be enabled by pressing the AUX button (see 18 in FIG. 1) for a predetermined amount of time (2 seconds). When the feature is enabled, an indicator, such as an AUX LED (24 in FIG. 1), may be activated. In spread only mode, the left momentary thumb switch (see e.g. 3 in FIG. 2) may operate the auxiliary spray system. If the standard Spray Mode is active, a momentary press of the AUX Spray button (see 18 FIG. 1) may operate the auxiliary spray system. An operator may use a three-way valve to select either using a hand wand or using a standard spray tip mounted on the front of the machine. In some instances, a press and release of the left momentary thumb switch 3 or AUX Spray button 18 may turn the auxiliary pump on allowing the system to spray continuously through the wand or a spray tip. Another quick press of this left thumb switch 3 or AUX Spray button 18 may then turn the system off. Further, to turn off the auxiliary spray feature, the operator may press and hold for 2 seconds the AUX button 18 on the control interface 1 and then LED 24 may also turn off. When the AUX spray tank is running, the PSI display 20 may blink with the display “AU” for auxiliary, so it is clear to the operator when the auxiliary tank is running.

On more advanced models, FIG. 8 shows how the system uses wheel speed sensor 42, 43 on the left and right drive wheel, respectively, to allow for accurate ground metering and turn compensation when applying product. The speed sensors 42, 43 on each the two rear wheels may be hall-effect sensors and send a pulse back to the controller as the wheel turns. The controller may then interpret these pulses and calculate the exact wheel speed of each tire. The speeds from both wheels may then be used together to calculate and average speed, so that when the machine is going straight (as shown in path 40) or when turning (as shown in path 41) the center line speed of the machine may be obtained. This speed is displayed on the speed display 8. Where there is a difference in the wheel speeds, as is known to occur when the machine turns (e.g. takes path 41), the controller knows the machine is turning. As illustrated in FIG. 8, the wheel speed sensor 42 is turning slower than the wheel speed sensor 43, so the controller knows the machine is turning to the left. In some instances, the magnitude of the difference in wheel speeds is used to understand the magnitude of the turn. The controller can interpret the wheel speeds and changes in each wheel speed to determine the machine speed, turning rate, and distance traveled which can be used to ground meter the spreading and spraying. While illustrated as including two wheel sensors, this is not intended to be limiting, in some instances, the machine may only include one wheel speed sensor.

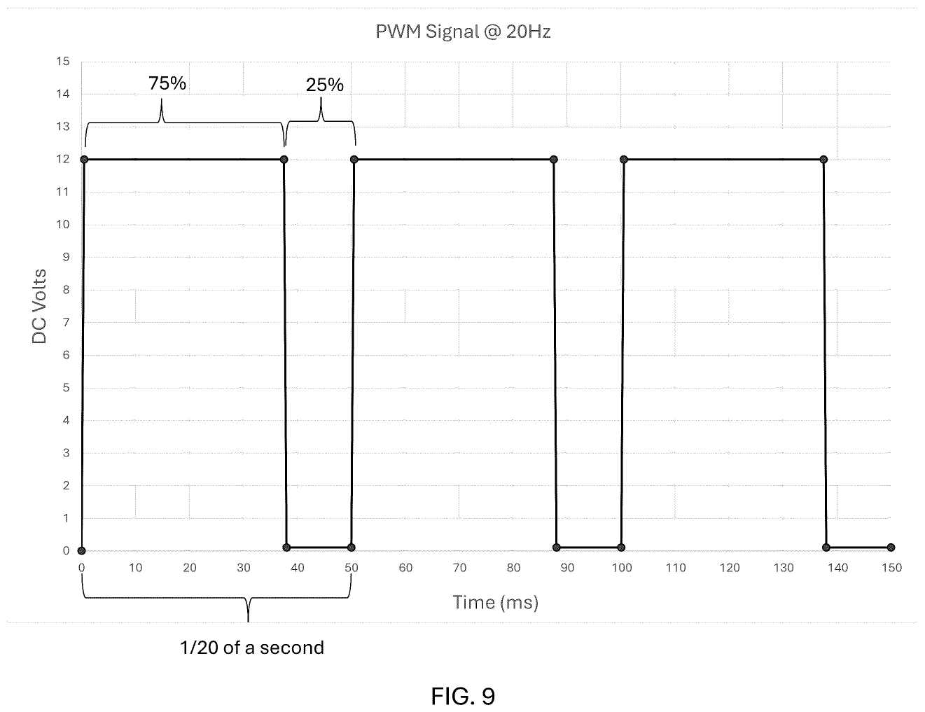

In some implementations, the spray tips 30, 32 may be controlled independently. Additionally, in some implementations, the spray tips utilize pulse width modulated (PWM) tips allowing the spray tips to turn on and off approximately 20-30 times per second. In FIG. 9, a PWM signal with a 20 Hz frequency is shown. The “on” voltage is at 12 volts, 75% of the time in this example, and at near zero volts 25% of the time in this example. In this example, the spray valve would be on 75% of the time reducing the maximum flow rate to 75%. The quick response time may allow the controller to regulate the spray flow rate by sending similar signals to each independent spray tip. In such instances, the spray tips may be powered with an approximately 12 v signal and when a continuous 12V is sent to the spray tips the spray tip operates like a normal spray tip at open flow. This flow rate may be used by the controller as the max flow rate for a single spray tip during calibrations. Additionally, the controller may send a 12 v signal to the PWM spray tip based on a percent of time “on” using a 20 Hz duty cycle, see FIG. 9. This percentage of on time will correlate to the percent flow rate out of the spray tip based on the max spray flow rate. This allows the controller to vary the flow rate with a consistent spray pressure by changing the percent duty cycle of the spray tips. In the instant example, the PWM duty cycle was 20 Hz but it could easily be faster or slower and provide the same function. A similar PWM signal is also used to control the speed of the spray pump and the spreader motor. A percentage of on time is used to regulate the speed of the pump to regulate spray pressure and a percentage of on time is used to regulate the spreader motor speed to control spreading width. While described and illustrated herein as a PWM spray tip, this is not to be understood as limiting, as any type of electronically controlled spray tip may be used.

The controller may use the wheel speed input data (e.g. from the wheel speed sensors 42, 43) to send a signal to the spray tips to match the spray flow rate for the given ground speed. The controller may have a target application rate, and it may be able to adjust the flow rates using the percent on duty cycle to accurately control and ground meter the spray system from the system max speed calculated based on the spray tip maximum flow rate down to approximately 20% of the max flow rate. In this example, if the max spray rate can be applied at 5 mph, the system can ground meter an accurate spray from 1 to 5 mph. This allows the system to spray chemicals at a constant application rate while adjusting for the change in ground speed.

An additional method of controlling the spray rate which allows for accurate spraying at very slow speeds is to determine a spray pulse length where at full application speed this pulse results in 100% on for the spray tip. For example, a machine with a maximum application speed of 5 mph would travel 88 in/sec. A speed 88 in/sec where the spray tip would active every 3″ would have a frequency of 29.3 Hz or 29.3 pulse per second. Using this you would calculate the on pulse length to be 0.034 seconds for every 3 inches of travel results in 100% on time for the spray tip as any speed 5 mph or faster. The machine will spray a pulse every time the spray tip travels a known distance, for this example its 3″. At full speed, the spray tip will fire a short pulse every 3″ of travel, but at full speed this keeps the spray tip on 100% of the time. As the machine shows, it takes longer to cover 3″ of travel and the spray tip begins to cycle off. As the machine gets slower, the spray pulse gets slower. As the machine gets faster, the spray pulse increases resulting in an even flow rate for the distance covered. This method results in the ability to spray accurately at very slow speeds. In this method, the user could set a minimum spray speed so the units shuts down automatically as the unit comes to a stop.

Additionally, as briefly described previously, the controller may also use the difference in wheel speed sensors to compensate for turning errors. The wheel speed sensors may be used by the controller to interpret each wheels exact speed. This data may then be used to calculate an average vehicle speed or distance travel. The difference in the two wheel speeds is then used to calculate a direction vector to compensate for turning errors. Traditionally, when a wide spray boom is turning, you get excessive spray to the inside and not enough spray on the outside. In the example illustrated in FIG. 8, if the machine follows path 41, the center spray tip 45 will spray a rate based on the average speed determined from the two wheel speed sensors 42, 43. The inside spray tip 46 may have its flow rate reduced to compensate for the shorter distance traveled through the turn compared to spray tip 45. The spray tip 44 located on the right of the machine will travel furthest during the turn and the flow rate will need to be increase proportionally to the decrease of spray tip 46.

In some implementations, this ground metering may be accomplished through the use of one or more GPS sensors. In such implementations, the controller may receive data regarding the speed of the machine from a GPS sensor. In other implementations, for example in a machine with an electric drive setup, the electric drive would get speed data from the controller, rather than a wheel speed sensor or GPS. In such implementations, the brushless electric motor knows its own speed. This may be particularly advantageous in embodiments that are battery powered. Regardless of how the wheel speed is determined, the controller may utilize the data as described above to alter the spread or spray rate, compensate for turning errors, etc.

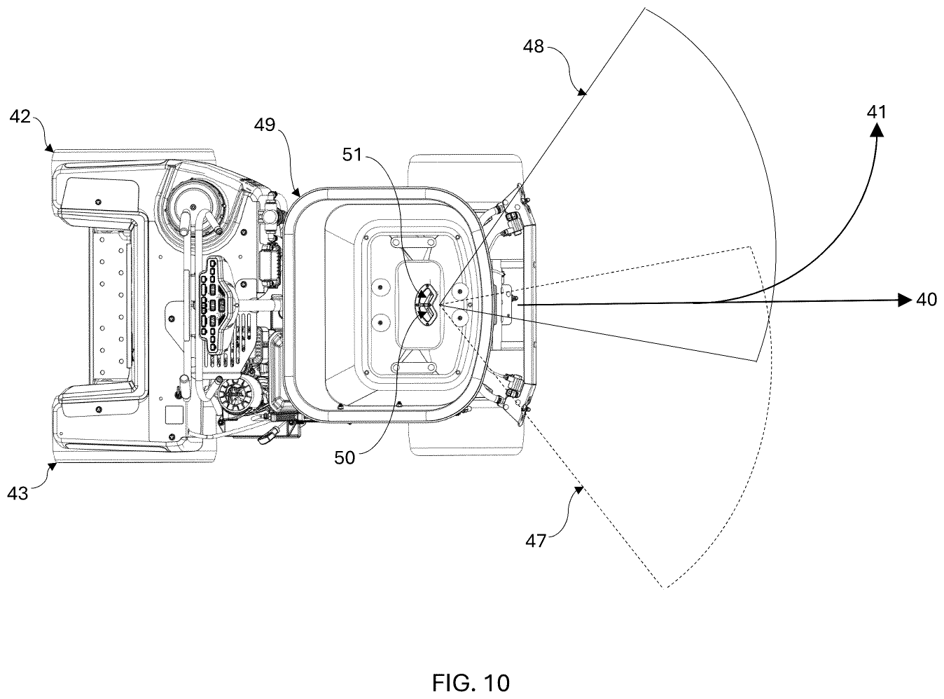

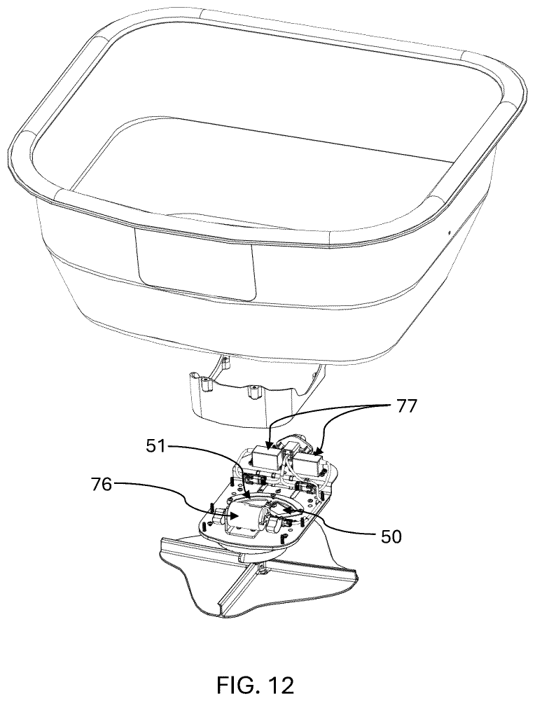

In FIG. 10, wheel speed sensors 42, 43 may also be used by the controller to regulate material flow to the spreader 49 for ground metering and turn compensation in a similar way as shown and described with reference to FIG. 8 for spraying. In the example in FIG. 10, the fertilizer spreader 49 may have two independent and electronically controlled material gates 50, 51. The spread pattern shows the material overlap for the left 48 and right 47 spread patterns. The controller may use the wheel speed sensor data (e.g. from wheel speed sensors 42, 43) to determine an average ground speed and then use that data to regulate, based on ground speed, the flow of material through the two fertilizer hopper openings as the machine travels along a substantially straight path 40. As the ground speed changes when turning along path 41, the flow rates need to change to keep an even application while turning. In this example, when the machine turns with two gate openings 50, 51 there is a difference in the wheel speeds, the controller may then use this difference in the wheel speeds in the same way as shown in the sprayer example in FIG. 8. In the instant example of FIG. 12, the gate opening 50 would be decreased because it supplies material to spread pattern 48 which travels a shorter distance through the turn than spread pattern 47. Fertilizer hopper gate opening 51 may increase proportionally to the decrease for fertilizer gate opening 50.

Wheel speed sensors may allow for ground metering and turn compensating, which may improve the material accuracy of an applicator, and may also save on the amount of material used. When doing the system calibration, the product being sprayed, or the product being spread, may have a best or recommended application rate based on the desired application rates of the product. As a part of the calibrate process, in some instances, the controller may be informed of, or may calculate, the maximum speed it can apply each product correctly. The PWM spray system can slow the spray rate accurately down to about 20% of the max flow rate. This number may be used to determine the speed range acceptable to operate and apply products. Where a system uses the wheel speed sensors and PWM spray tips, the system may not allow an operator to apply any chemical (spraying or spreading) below the minimum effective speed which is approximately 20% of the calculated max effective speed if limited the percent on PWM spray logic or less than 1% of the max effective speed if using ground based PWM spray logic. Likewise, if the machine exceeds the maximum effective speed, the system can turn off the material flow rate or provide an indication (e.g., a display blinking rapidly) notifying the operator they have exceeded the max speed, and thus may be under applying product. The ground metering for both the spreader and sprayer will allow for more accurate applications of products and prevent accidental burning of lawns when the user forgets to turn the sprayer or spreader off when coming to a stop. With ground metering, the machine can only apply product when moving and at the recommended rate for the speed currently traveling.

In some instances, the system may include one or more wheel speed sensors 42, 43, but no PWM spray tips. In such instances, the system may limit the operator to only applying product where the ground speed is adequate for the product being applied. For example, if the system is setup to apply at 5 mph, the system could have a 10% tolerance on the acceptable ground speed. This would allow the operator drive at a target speed of 5 mph but allow the machine to only apply product at speeds of approximately 4.5 to 5.5 mph.

Calibrating an applicator for spreading and spraying is a difficult task for most operators. In order to calibrate the application, an operator needs to match the material flow, with the width of the application, the desired ground speed, and the product and/or concentration of the product is sprayed being applied. The controller described herein may reduce the complexity and the time required to calibrate a machine.

In some instances, the controller may come with preset calibration. For example, the spread and spray modes may have one or more preset calibration settings, which may be labeled A, B, and C . . . while customer stored calibration settings may be saved as 1 through 9. When an operator is selecting the spray or spread mode initially, they can also select the product calibration program for the particular product being applied.

As a non-limiting example, an operator may set and select a spread calibration program by toggling through the “A” button 26 (FIG. 1). In some instances, the controller may initially have factory options A, B, and C described above. When an operator selects the “A” button 26 the program will toggle through the available calibration programs and display them in the hopper display 21. In some instances, when the machine is in stand by mode, and thus not applying product, the hopper display 21 displays the calibration selected.

As another non-limiting example, an operator may set and select a spray calibration program by toggling through the “B” button 27. In some instances, the controller may initially have factory options A, B, and C. When an operator selects the “B” button the program will toggle through the calibration programs and display them in the PSI display 20. When the machine is in stand by, and thus not applying product, the PSI display 20 displays the calibration selected.

In some instances, an operator may setup and save a new calibration by pressing and hold the two calibration buttons 4, 5 simultaneously for a predetermined length of time (for example, 10 seconds). After the predetermined length of time (e.g. 10 seconds) the display 20, 21, 22 will go blank and only the speed display 8 will display “CA” for calibration mode. The operator may then press “A” 26 to continue with a spreader calibration or “B” 27 to continue with a sprayer calibration.

For a sprayer calibration process, an operator may enter the calibration mode and then select “B” 26. The operator may then continue to toggle through to select a desired program number that will be used to the calibration being programed, and then select “enter” or the center of the wide arrow button 10. The tank may be partially filled with the correct chemical solution to be sprayed in the spray tank, and an operation may need to ensure the mixture is the correct concertation and mixed thoroughly. The following represent exemplary steps for spray calibration for a sprayer with three PWM spray tips and a fertilizer hopper with two servo-controlled openings. However, it is to be understood the specific calibration process may vary, for example based on the number of spray tips, whether PWM spray tips are used, and the fertilizer hopper configuration.

Continuing with the calibration process, the spray lines may be purged by operating the spray tips individually. It may be desirable to place a catch container under each tip while purging the lines. To manually purge the spray lines, the spray button 4 may be pressed and held, and the spray pump will turn on to spray material through the spray tips clearing the lines for calibration. To adjust the spray pressure (30 psi may be standard), an operator may press the right arrow 9 to increase desired pressure, or the left arrow 11 to decrease the desired pressure. Select “enter” or center button 10 when the desired pressure has been selected and the control will move to the next step.

An operator may then place an empty container with graduation increments (for example in fluid ounces) under the left spray tip. The operator may then press and hold button 4 to begin spraying out of the left tip only and stop before exceeding 99 fluid ounces. The center impeller display 22 may show 00 for zero ounces, an operator may then enter the number of ounces in the container using the right arrow 9 to increase the number and the left arrow 11 to decrease the number. Once the correct number of ounces are entered, press the “enter” or center button 10. This process is then repeated for the right spray tip, and the center spray tip.

Next an operator may enter the rate the product is to be applied, for example in gallons per 1000 square feet. The center impeller display 22 may show 0.0 for zero gallons per 1000 square feet. An operator may use the right arrow 9 to increase and the left arrow 11 to decrease the desired rate. Once the rate is correct, the operator may press “enter” 10.

The speed display 8 may now show and toggle between “CA” for calibration and the maximum speed capable with the calibration run just calculated by the controller given the user inputs. An operator may press “enter” 10 to exit and save the calibration or press and hold the spray mode button 4 for a predetermined length of time, for example two seconds, to go back to setup.

Generally, the maximum speed number should be at or just above the desired maximum speed for the equipment. Conventionally, this is about 5.5 to about 8 mph depending on the machine. If the value is lower or much higher than desired, it may be recommended to change the parameters used in the calibration run. This may change the flow rate from the spray tips and pressure, or an operator may change the rate at which the product is applied to dial in an optimum maximum speed. In some instances, an operator may also change the concentration of the chemical solutions in the spray tank.

For a spread calibration process, an operator may enter calibration mode and then select “A” 26. The operator may then continue to toggle through to select a desired program number that will be used to the calibration being programed, and then select “enter” or the center of the wide arrow button 10. The operator may then fill the hopper about one half full of the material being calibrated then follow the below exemplary sequence. As an initial matter, the operator may remove the impeller disk prior to beginning the spreader calibration.

An operator may enter a desired spread (or wide) width in feet. The center impeller display 22 may, in some implementations, show 16 feet as a default, this is not intended to be limiting and may be preprogrammed to any desired preset. An operator may use the right arrow 9 to increase and the left arrow 11 to decrease the desired width. The spread width should be approximately two times the wide spray width for about 50% overlap when spreading.

Next the operator may enter a desired maximum travel speed. Normally, this should match the maximum speed obtained during calibration of the sprayer. Normally between about 5.5 to about 8.0 mph.

An operator may then enter a fertilizer prill size. In some implementations, the system may provide options are 1 through 5 for fertilizer size; generally option 3 is the most common fertilizer prill size and may be recommended for a starting point if an operator is unsure. Use the right arrow 9 to increase and the left arrow 11 to decrease the desired prill size. The operator may then press “enter” 10 when complete.

An operator may then select the hopper vibration intensity mode, which may affect the flow rate of the material. An operator may press enter to use the standard slow vibration mode, while an operator may press the hopper vibration button 19 to scroll through the various speed settings. When the desired setting is achieved an operator may press “enter” 10.

An operator may place a catch tray under the hopper opening and press and hold the spreader mode button 5 until the catch container is mostly full. The hopper opening for the calibration run is predetermined based on the prill size selected in the previous setup. The material in the catch contain may then be weighed, for example in pounds. The center impeller display 22 will show 0.0 pounds, and the operator may then use the right arrow 9 to increase and the left arrow 11 to decrease to enter weight of the material captured, for example in pounds. Once the correct weight is entered, the operator may press “enter” 10. In some applications, additional calibration settings (data points) may be required to provide a calibration curve or line so the controller can determine the flow rate desired for the given ground speed of the machine.

The speed display 8 may now show and toggle between “CA” for calibration and the maximum speed capable with the calibration run just selected tested. This number should be the same or greater than the maximum speed calculated during the sprayer calibration if the operator will be spreading and spraying at the same time.

An operator may also enter a desired narrow spread width in feet. The center impeller display 22 may default to 8.0 feet; however, this is not intended to be limiting as the default may be set to any desired value. The operator may use the right arrow 9 to increase and the left arrow 11 to decrease the desired width. Generally, the spread width should be two times your narrow spray width for 50% overlap when spreading in the narrow mode. An operator may press enter once the narrow spread width has been entered.

The operator may install the fertilizer spreader impellar and spread material to determine the proper impeller speed to achieve the wide spreader width entered as described above. This number in feet will be displayed in the hopper window 21. The center impeller display 22 may default to 50 for a starting point of 50% of the maximum for the impeller speed; however, this is not intended to be limiting, as any speed may be set as the default starting point. In some implementations, the impeller speed range may be 0-99. An operator may use the right arrow 9 to increase and the left arrow 11 to decrease the impeller speed setting. The operator may press and hold the spreader mode button 5, which may spin up the impeller for a predetermined length of time, for example two seconds, and then open the fertilizer hopper to visually check the spreader width. The operator may then release the spread mode button 5 to stop the impeller and material flow, and then press enter to accept the speed testing results or may adjust the impeller speed using the arrow buttons. It may be desirable, in some implementations, to rerun the test by pressing and holding the spreader mode button 5.

An operator may next calibrate the impeller speed to match the narrow width setting entered as described above. The narrow width above may be displayed in feet in the hopper window 21, while the center impeller display 22 may show a predetermined value (for example 10) as a starting point for the impeller speed. In some implementations, the impeller speed range may be 0-99. An operator may use the right arrow 9 to increase and the left arrow 11 to decrease the impeller speed setting; pressing and holding the spreader mode button 5 may spin up the impeller for a predetermined length of time, for example two seconds. An operator may then open the fertilizer hopper in order to visually check the spreader width. Once the operator releases the spread mode button 5 the impeller and material flow are stopped. The operator may then press enter to accept the speed testing results or adjust the rate using the arrow buttons. In some instances, it may be desirable to rerun the test, which may be accomplished by pressing and holding the spreader mode button 5. Once an impeller speed matches the narrow spread width the operator may press “enter” 10 to exit and save the setting.

The custom calibration process may allow a user to create their own calibration runs for the most accurate application rates available. Custom calibrations also provide a tighter and more restrictive control over the materials being applied, for example, for larger users who may run a fleet of machines per location. The use of stored calibrations can greatly limit the customization of the machine to what the user desires. Typically, it is the service manager for a lawncare company that is the individual who calibrates and is responsible for the products applied to lawns. With the invention presented herein, the service manager may now have the option to setup a single calibration where the user cannot change anything, or the manager can setup as many as five (5) spread and/or five (5) spray calibrations where the user can select different options setup by the service manager.

An example of spread and spray calibration tables or data stored by the control is illustrated in FIGS. 16 and 17, respectively. This is an example and not intended to be limiting in nature. The usefulness of having preset or custom calibrations for a tighter control for applying restricted chemicals and fertilizers increases both accuracy, safety, and profitability.

FIG. 15 is a block diagram of an example control system 80 shown and described herein. As shown in FIG. 12, control may in some instances, be an electronic control unit (ECU) 55, which may include one or more processors 71 and a memory 72 within which may be stored program code for execution by the one or more processors. The memory may be embedded in the ECU 55 but may also be considered to include volatile and/or non-volatile memories, cache memories, flash memories, programmable read-only memories, etc., as well as memory storage physically located elsewhere from the ECU 55. The ECU 55 may be interfaced with various components. The ECU 55 may interface with various user controls; for example, the control interface 56 (such as control interface 1 illustrated in FIG. 1), and thumb switches 70 (for example switches 2, 3 illustrated in FIG. 2), etc. The ECU 55 may also be interfaced with the PWM spray tip(s) 57, agitator output 58, parking brake actuator 60, deflector actuator 61, additional accessory power output 62, impeller motor output 63, pump motor output 64, vehicle (e.g. applicator) battery 65, vehicle key switch 66, wheel speed sensor(s) 67, pressure transducer 68, servo-control gate(s) 69 for the fertilizer hopper.

In some embodiments, ECU 55 may also be coupled to one or more network interfaces 73, e.g., for interfacing with external devices via wired and/or wireless networks such as Ethernet, Wi-Fi, Bluetooth, NFC, cellular and other suitable networks, collectively represented in FIG. 15 at 74. One non-limiting example of such a network interface may be a Bluetooth chip. Network 74 may incorporate, in some embodiments, wireless protocols, e.g., Wi-Fi or Bluetooth, may be used. In some embodiments, ECU 55 of the applicator may be interfaced with one or more user devices 75 over network 74, e.g., computers, tablets, smart phones, wearable devices, etc., and through which applicator may be controlled and/or may provide user feedback. Various alternative or additional hardware or configurations for network interface 73 will be apparent to one of ordinary skill in the art.

In some implementations, an operator may be able to utilize an application of a user device 75 to select from a list of preset or custom calibrations stored that the application of the user device 75, which may then be able to instruct the applicator machine via network 74 to execute the selected commands. An operator, via user device 75 may also be able to download, for example via network 74, a custom calibration created by an operator and transfer this calibration to one or more other networked applicator machines. A connected user device 75 may also, in some implementations, be able to display detailed application information to the operator either in real time or records or past application for an operator to maintain in their application records. A non-limiting example of the information displayed in real time and/or recorded via the user device 75 include: an amount of area covered during an application; an amount of product applied to that point during an application; an amount of product left in the spreader or spray tank (e.g. range indicator); a summary of product applied after the application; information regarding the area treated after the application (e.g. a map or other description of the area treated). Additionally, in some implementations, an operator may be able to reset the summary information after each application. Traditionally, it may be desired that an operator record area treated and the amount of product applied (e.g. when doing lawn applications), but currently this may be accomplished via inconsistent and inaccurate paper records, that may amount to a best guess of the operator. Such a connected system may allow for more accurate and consistent records that may be easily viewable and sharable with a third party.

For example, a third-party schedule routing software may also be networked with the ECU 55 of the applicator machine and/or the user device 75 to allow a lawncare company to easily develop and schedule a route for the day. This route may then be displayed to an operator via the user device 75. The operator may then be able to follow the scheduled route, while the connected user device 75 may record the amount of product applied, area covered, length of time at the job sire, and time of application for each of the scheduled jobs on the route. At the end of the day, a lawncare company may then be able to access this information for each customer to aid in record keeping and billing.

While described herein primarily as an ECU, control of one or more of the various components described herein may control through one or more physical components (e.g. cables, chains, etc.) either alone or in combination with an ECU 55.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1-20. (canceled)

21. A ground applicator control system, the control system comprising:
one or more electronically controlled gates configured to dispense a plurality of granules;
one or more electronically controlled spray tips configured to dispense a liquid product;
an operator control interface; and
a controller;
wherein the controller is coupled to the operator control interface, the one or more electronically controlled gates, and the one or more electronically controlled spray tips, the controller configured to:
receive, from the operator control interface, a mode selection;
dispense, the liquid product or the granule product, based on the mode selection.

22. The ground applicator machine of claim 21, wherein the controller is further configured to:
receive, from the operator control interface, a pattern selection; and
dispense, the liquid product or the granule product, based on the mode selection and the pattern selection.

23. The ground applicator machine of claim 21, wherein the controller is further configured to:
receive, from the operator control interface, a calibration selection; and
dispense, the liquid product or the granule product, based on the mode selection and the calibration selection.

24. The ground applicator machine of claim 23, wherein the calibration selection received from the operator control interface is a selection a preset calibration or a custom calibration.

25. The ground applicator machine of claim 24, wherein in the custom calibration includes the controller being further configured to:
determine a maximum speed the one or more electronically controlled gates can dispense the plurality of granules; or
determine a maximum speed the one or more electronically controlled spray tips can dispense the liquid product.

26. The ground applicator control of claim 21, wherein the one or more electronically controlled gates or the one or more electronically controlled spray tips stop dispensing when the ground applicator is below a minimum speed.

27. The ground applicator control of claim 21 further including one or more speed sensors configured to regulate dispensing from the one or more electronically controlled gates or the one or more electronically controlled spray tips.

28. The ground applicator control of claim 27, wherein the one or more speed sensors includes a first speed sensor and a second speed sensor, and wherein the controller is further configured to:
determine, based on the first and second speed sensors, whether the ground applicator is turning
determine, based on the first and second speed sensors, a direction and a magnitude of the turn;
dispense, the liquid product or the granule product, based on the direction and the magnitude of the turn.

29. The ground applicator control system of claim 21, wherein controller is further configured to ground meter a flow of the liquid product or a flow of the plurality of granules based on speed data from one or more speed sensors.

30. The ground applicator control system of claim 21 further comprising a spray pump, wherein a speed of the spray pump varies.

31. The ground applicator control system of claim 30, wherein the speed of the spray pump increases when the one or more electronically controlled spray tips are activated.

32. The ground applicator control system of claim 21, wherein the controller is further configured to:
receive, from the operator control interface, an auxiliary input; and
dispense an additional amount of the liquid product based on the auxiliary input.

33. A ground applicator control system for application of granular material, the system comprising:
one or more electronically controlled gates configured to dispense a plurality of granules;
one or more variable speed spreading disks;
an operator control interface; and
a controller;
wherein the controller is coupled to the operator control interface, the one or more electronically controlled gates, and the one or more variable speed spreading disks, the controller configured to:
receive, from the operator control interface, a user selection;
wherein the user selection is variable by the user; or
wherein the user selection is one or more preset selections;
dispense, the plurality of granules, based on the user selection.

34. The ground applicator control system of claim 33, wherein the user selection further includes a spread width.

35. The ground applicator control system of claim 33, wherein the user selection further includes selection of spreading predominately to a right side, a left side, or a center.

36. The ground applicator control system of claim 33, wherein the one or more electronically controlled gates stop dispensing when the ground applicator is below a minimum speed.

37. The ground applicator control system of claim 33 further comprising a hopper and a material vibrator, wherein the material vibrator is coupled to the controller and the controller is further configured to activate the material vibrator when the one or more electronically controlled gates are open.

38. A ground applicator control system for application of liquid material, the system comprising:
one or more electronically controlled spray tips configured to dispense a liquid product;
one or more electronically controlled spray pumps;
an operator control interface; and
a controller;
wherein the controller is coupled to the operator control interface, the one or more electronically controlled spray tips, and one or more electronically controlled spray pumps, the controller configured to:
receive, from the operator control interface, a user selection;
wherein the user selection is variable by the user; or
wherein the user selection is one or more preset selections;
dispense, the liquid product, based on the user selection.

39. The ground applicator control system of claim 38, wherein the user selection further includes a spray width.

40. The ground applicator control system of claim 38, wherein the user selection further includes selection of spraying predominately to a right side, a left side, or a center.

41. The ground applicator control system of claim 38, wherein the one or more electronically controlled spray tips stop dispensing when the ground applicator is below a minimum speed.
